(19) United States
(12) Patent Application Publication
(10) Pub. No.: US 2007/0209942 A1
(43) Pub. Date: Sep. 13, 2007

(54) Device for separating anolyte from catholyte in electrolyzer

(76) Inventor: Wen Shing Shyu, Taichung (TW)

Correspondence Address: CHARLES E. BAXLEY, ESQ., 90 JOHN STREET, THIRD FLOOR, NEW YORK, NY, 10038, US

(21) Appl. No.: 11/370,439

(22) Filed: Mar. 8, 2006

(51) Int. Cl. B01D 61/42

(52) U.S. Cl. 204/627; 204/518

(57) ABSTRACT

An electrolyzer inc;ides a receptacle having a chamber and an inlet port for receiving an electrolytic solution, one or more cathode plates and one or more anode plates disposed alternatively in the receptacle and separated from each other for forming flowing passages between the cathode plates and the anode plates, the cathode plates may generate and attract anolyte toward the cathode plate, and the anode plates may generate and attract catholyte toward the anode plate The receptacle two separated compartments communicating with the chamber of the receptacle, and a guiding device may effectively guide the catholyte and the anolyte to flow into the two compartments of the receptacle respectively.

### BACKGROUND OF THE INVENTION

1. Field of the Invention

The present invention relates to a separating device, and more particularly to a separating device for separating anolyte from catholyte in electrolytic cells or electrolyzers or for preventing the anolyte and the catholyte from being mixed or blended with each other.

2. Description of the Prior Art

Typical electrolytic cells or electrolyzers comprise anodes and cathodes disposed within a cell body or container that is provided for receiving electrolyte therein, for generating anolyte and catholyte by energizing or actuating or operating the anodes and the cathodes, and for utilizing the anolyte and the catholyte to electroplate work pieces, for example.

In some circumstances, the anolyte and the catholyte are required to be separated from each other, for such as manufacturing or separating chlorine and caustic from brine. Accordingly, one or more separators or separating devices are required to be disposed or engaged into the electrolytic cells or electrolyzers for separating the anolyte and the catholyte from each other in the typical electrolytic cells.

For example, U.S. Pat. No. 4,292,146 to Chang et al. discloses one of the typical electrolytic cells including a porous polyfluoroalkylene sheet disposed therein and acted as a separator for the electrolysis of brine and for separating the anolyte and the catholyte from each other.

However, the typical porous polyfluoroalkylene sheet is good enough for separating the anolyte and the catholyte from each other in a static or motionless electrolyte in the electrolytic cells or electrolyzers, but the typical electrolytic cells or electrolyzers have no devices for separating and collecting the anolyte and the catholyte from the flowing electrolyte.

The present invention has arisen to mitigate and/or obviate the afore-described disadvantages of the conventional separating devices for separating the anolyte and the catholyte from each other in the electrolytic cells or electrolyzers.

### SUMMARY OF THE INVENTION

The primary objective of the present invention is to provide a separating device for separating anolyte from catholyte in electrolytic cells or electrolyzers or for preventing the anolyte and the catholyte from being mixed or blended with each other.

In accordance with one aspect of the invention, there is provided an electrolyzer comprising a receptacle including a chamber formed in the receptacle, and including an inlet port for receiving an electrolytic solution, at least one cathode plate and at least one anode plate disposed in the chamber of the receptacle and separated from each other for forming a flowing passage between the cathode plate and the anode plate, the cathode plate being provided for attracting anolyte of the electrolytic solution toward the cathode plate, and the anode plate being provided for attracting catholyte of the electrolytic solution toward the anode plate, the receptacle including a first compartment and a second compartment communicating with the chamber of the receptacle respectively, the first and the second compartments being separated from each other and not communicating with each other, and a guiding device for guiding the catholyte and the anolyte to flow into the first and the second compartments of the receptacle respectively.

The receptacle includes a conduit formed in the receptacle and communicating with the first compartment of the receptacle, and an outlet port communicating with the conduit for flowing out the catholyte.

The receptacle includes a partition disposed between the first compartment and the conduit of the receptacle, and a passage formed in the partition for communicating the first compartment with the conduit of the receptacle.

The receptacle includes two housing members secured together, the housing members each includes the outlet port formed therein, and a coupler coupled to the outlet ports of the housing members respectively.

The receptacle includes a window for blocking the first compartment with the conduit of the receptacle and for allowing a flowing of the catholyte from the first compartment toward the conduit of the receptacle to be seen by people. The receptacle includes an exit communicating with the second compartment for flowing out the anolyte.

The receptacle includes at least one peg extended therefrom and engaged through the cathode plate and the anode plate for stably supporting and anchoring the cathode plate and the anode plate in the chamber of the receptacle.

One or more spacers are disposed between the cathode plate and the anode plate for separating the cathode plate and the anode plate from each other. The cathode plate includes at least one groove formed therein, and the spacer includes a portion engaged into the groove of the cathode plate.

The guiding device includes a deflector extended from the cathode plate and extended into the first compartment of the receptacle for guiding the catholyte to flow into the first compartment of the receptacle.

The guiding device includes a guiding projection extended and directed into a middle portion of the flowing passage which is formed between the cathode plate and the anode plate for separating the catholyte and the anolyte from each other, and for guiding the catholyte to flow into the first compartment of the receptacle and for guiding the anolyte to flow into the second compartment of the receptacle.

The receptacle includes a partition disposed between the first and the second compartments for separating the first and the second compartments from each other, and the guiding projection is extended from the partition.

The receptacle includes a buffer space communicating with the chamber and the inlet port of the receptacle. The buffer space includes an area greater than that of the inlet port of the receptacle for buffering the electrolytic solution.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an electrolytic cell or electrolyzer having a separating device in accordance with the present invention;

FIG. 2 is a perspective view of the electrolyzer having the separating device disposed therein,

FIG. 3 is an enlarged partial perspective view of the electrolytic cell or electrolyzer;

FIG. 4 is a front plan schematic view of the electrolytic cell or electrolyzer;

FIG. 5 is a cross sectional view of the electrolyzer taken along lines 5-5 of FIG. 4, illustrating the operation of the separating device;

FIG. 6 is an enlarged partial cross sectional view of the electrolyzer as shown in FIGS. 4 and 5;

FIG. 7 is another enlarged partial cross sectional view illustrating the distribution of the anolyte and the catholyte in the electrolyzer;

FIG. 8 is a front plan schematic view similar to FIG. 4, illustrating the other arrangement of the electrolytic cell or electrolyzer;

FIG. 9 is a cross sectional view of the electrolyzer taken along lines 9-9 of FIG. 8;

FIG. 10 is an enlarged partial cross sectional view of the electrolyzer as shown in FIGS. 8 and 9;

FIG. 11 is an exploded view similar to FIG. 1, illustrating the further arrangement of the electrolyzer;

FIG. 12 is a front plan schematic view of the electrolyzer as shown in FIG. 11;

FIG. 13 is a cross sectional view of the electrolyzer taken along lines 13-13 of FIG. 12;

FIG. 14 is an enlarged partial cross sectional view of the electrolyzer as shown in FIGS. 11-13;

FIG. 15 is a front plan schematic view similar to FIGS. 4, 8, 12, illustrating the still further arrangement of the electrolytic cell or electrolyzer;

FIG. 16 is a cross sectional view of the electrolyzer taken along lines 16-16 of FIG. 15; and

FIG. 17 is an enlarged partial cross sectional view of the electrolyzer as shown in FIGS. 15-16.

### DESCRIPTION OF THE PREFERRED EMBODIMENT

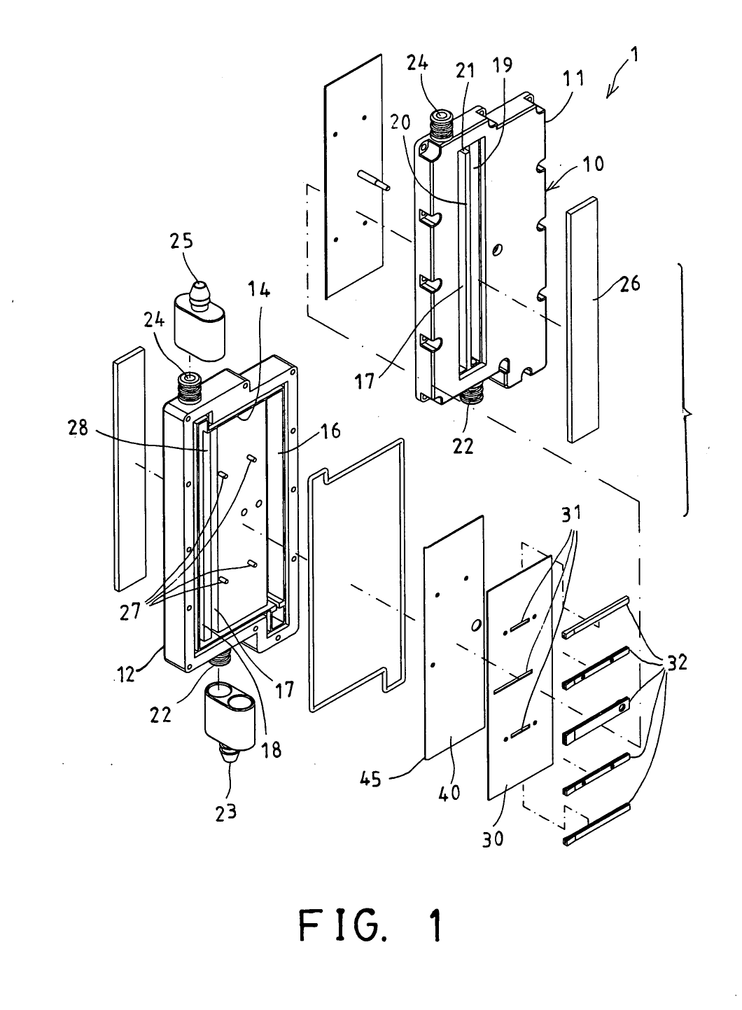

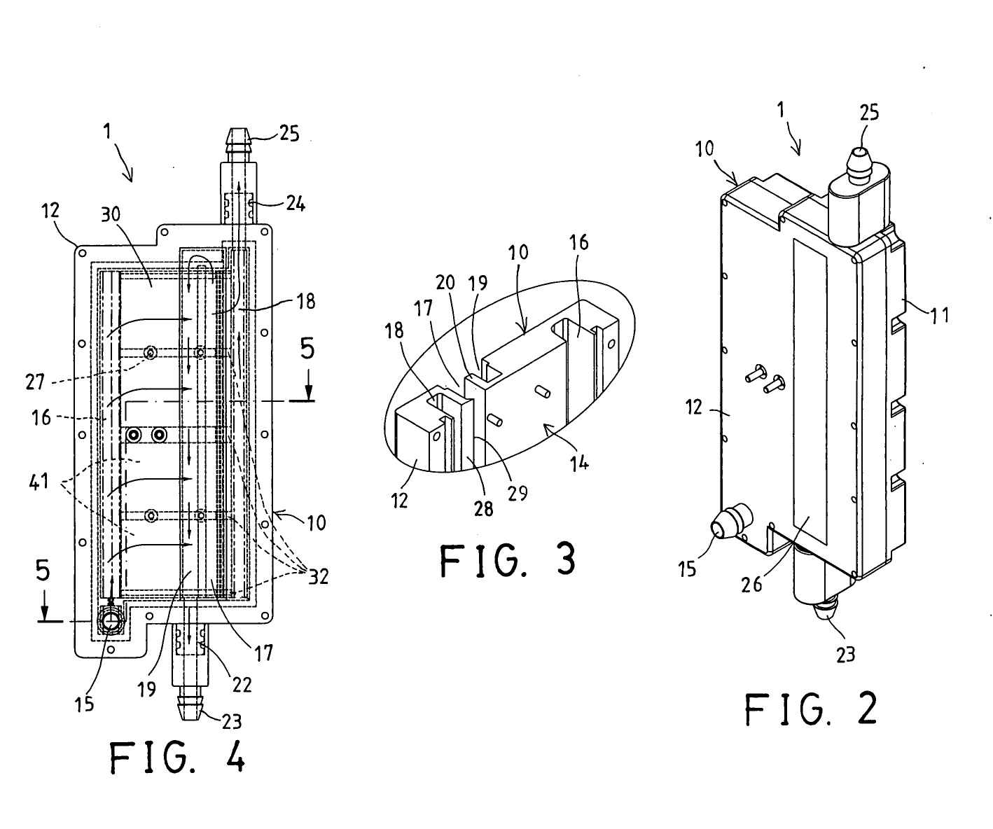

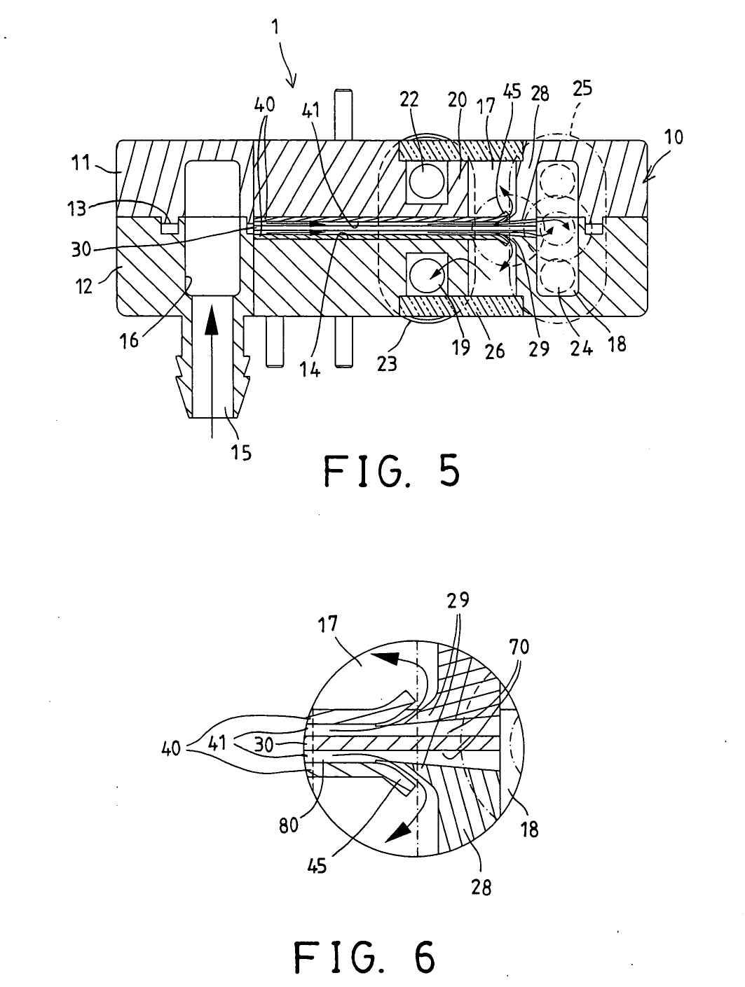

Referring to the drawings, and initially to FIGS. 1-5, an electrolytic cell or electrolyzer 1 in accordance with the present invention comprises an outer receptacle 10 formed by or including two separated housing members 11, 12 that may be secured together with such as fasteners or latches 13 (FIG. 5), or the like, and a space or chamber 14 formed in the receptacle 10 and defined between the housing members 11, 12 (FIGS. 1, 5). The receptacle 10 includes an inlet port 15 formed therein, such as formed and located in the lower portion thereof for receiving such as the brine or other electrolytic solutions.

The receptacle 10 further includes a buffer space 16 formed therein, such as formed in one side of the receptacle 10 and communicating with the chamber 14 and the inlet port 15 of the receptacle 10 for allowing the electrolytic solutions from the inlet port 15 to flow into the chamber 14 of the receptacle 10. It is preferable that the buffer space 16 of the receptacle 10 includes a cross section or area or volume greater than that of the inlet port 15 of the receptacle 10 for slowing or buffering the flowing speed of the electrolytic solutions and for preventing eddy current from being generated with the electrolytic solutions.

The receptacle 10 further includes a first compartment 17 and a second compartment 18 formed therein, such as formed in the other side of the receptacle 10 and opposite to the buffer space 16 of the receptacle 10, in which the first and the second compartments 17, 18 are communicating with the chamber 14 of the receptacle 10 respectively, but the first and the second compartments 17, 18 are not communicating with each other and are separated from each other, best shown in FIG. 5, and are provided for receiving the anolyte and the catholyte respectively and thus for preventing the anolyte and the catholyte from being mixed or blended with each other, which will be discussed hereinafter.

The receptacle 10 further includes a conduit 19 formed therein, such as formed in the middle portion of the receptacle 10 and communicating with or coupling to the first compartment 17 of the receptacle 10. For example, a partition 20 is provided between the first compartment 17 and the conduit 19 of the receptacle 10, and a gap or passage 21 is formed or provided in the upper portion of the partition 20 for communicating with or coupling the first compartment 17 with the conduit 19 of the receptacle 10. It is preferable that the housing members 11, 12 each includes a first compartment 17 and a second compartment 18 and a conduit 19 formed therein, best shown in FIG. 5, and each includes a transparent window 26 for blocking the first compartment 17 with the conduit 19 of the receptacle 10 and for allowing the flowing of the electrolytic solution from the first compartment 17 toward the conduit 19 of the receptacle 10 to be seen by people.

The housing members 11, 12 each further includes an outlet port 22 formed therein and communicating with or coupling to the conduit 19 of the housing members 11, 12 respectively for receiving the electrolytic solutions, such as the catholyte or the anolyte respectively, and the receptacle 10 further includes a coupler 23 coupled to the outlet ports 22 of the housing members 11, 12 respectively for receiving and collecting the electrolytic solutions from the conduit 19 of the housing members 11, 12 respectively, and for allowing such as the catholyte to be collected and flown out of the receptacle 10.

The housing members 11, 12 each further includes an exit 24 formed therein and communicating with or coupling to the second compartment 18 of the housing members 11, 12 respectively for receiving the other electrolytic solutions, such as the anolyte or the catholyte respectively, and the receptacle 10 further includes a connector 25 coupled to the exits 24 of the housing members 11, 12 respectively for receiving and collecting the electrolytic solutions from the second compartments 18 of the housing members 11, 12 respectively, and for allowing such as the anolyte to be collected and flown out of the receptacle 10.

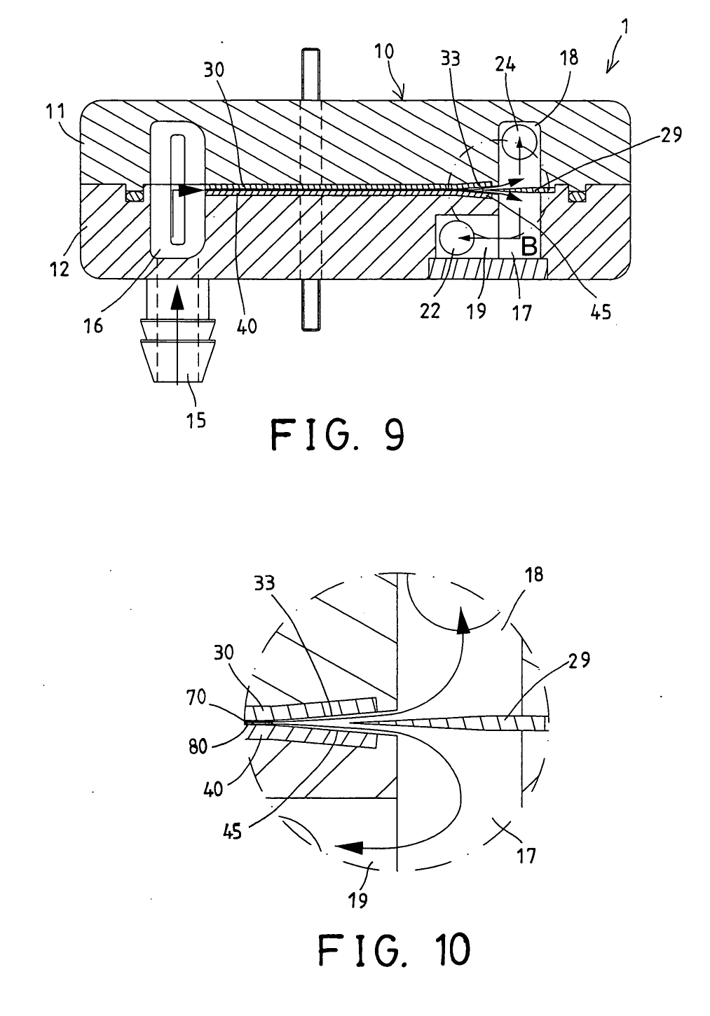

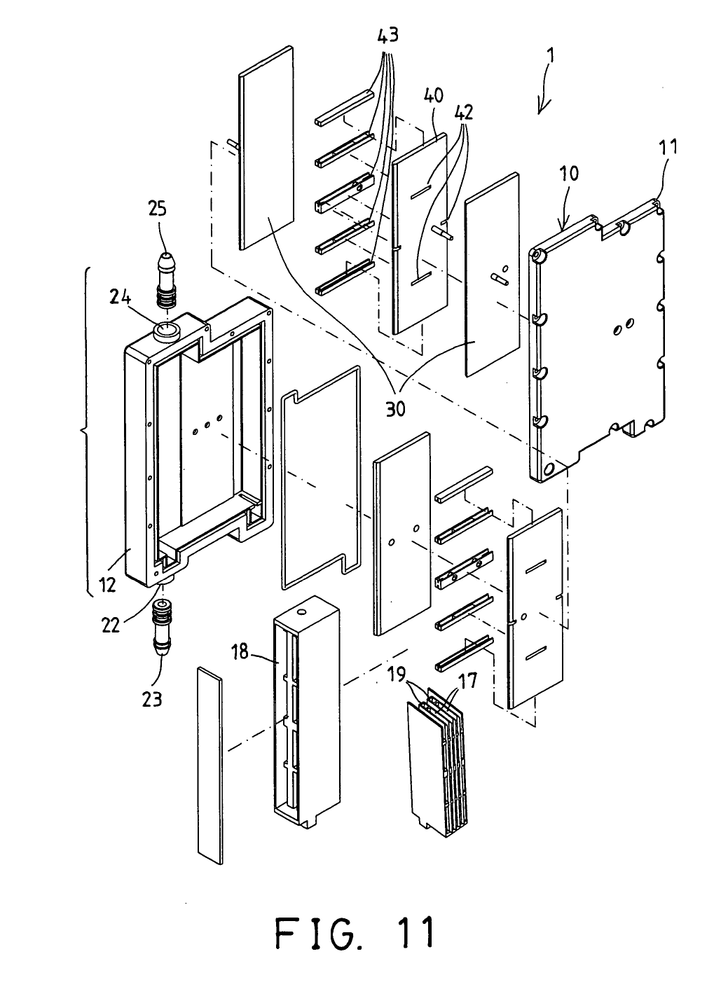

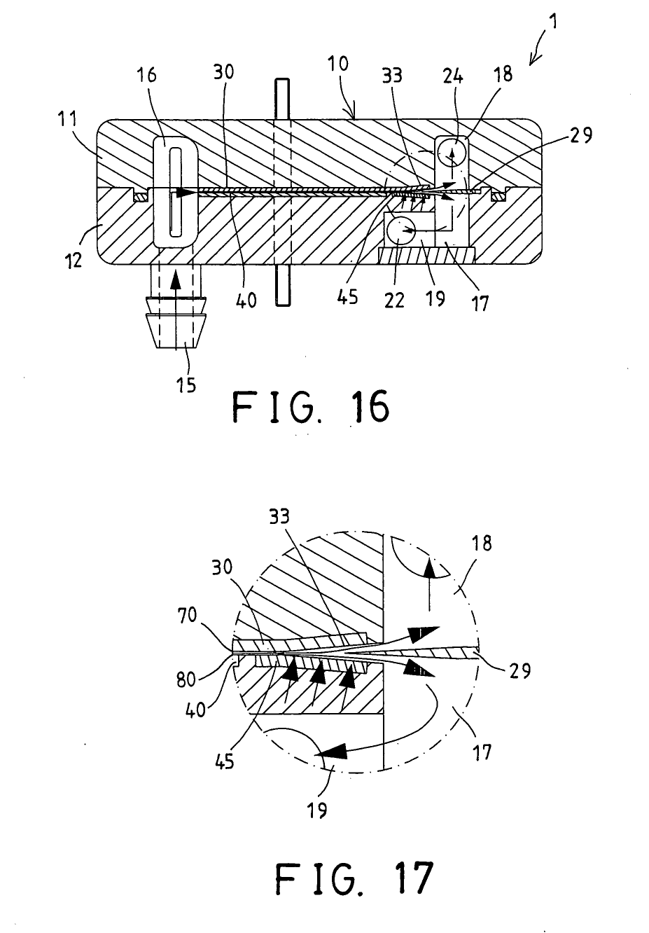

One or more cathode plates 30 and one or more anode plates 40 are disposed or engaged into the chamber 14 of the receptacle 10 and preferably disposed or arranged alternatively relative to each other. For example, as shown in FIGS. 1 and 5-6, one cathode plate 30 is disposed or arranged between two anode plates 40. Alternatively, one single anode plate 40 may be provided and disposed beside one single cathode plate 30, as shown in FIGS. 8-10 and 15-17; or two or more cathode plates 30 and two or more anode plates 40 may be provided and disposed into the chamber 14 of the receptacle 10 and arranged alternatively relative to each other, as shown in FIGS. 11-14. The cathode plates 30 and the anode plates 40 are preferably disposed parallel to each other.

As shown in FIG. 1, the cathode plate 30 includes one or more grooves 31, such as lateral or horizontal grooves 31 formed therein, and one or more bars or spacers 32 are formed or attached or secured onto two opposite sides of the cathode plate 30 for engaging with the anode plates 40 and for separating the cathode plates 30 and the anode plates 40 away from each other, and for forming or defining the flowing passage 41 between the cathode plates 30 and the anode plates 40 (FIGS. 4-6). For example, the spacers 32 may be formed or attached or secured onto the cathode plate 30 with such as molding or mold injection processes, for allowing a coupling material or a portion of the spacers 32 to be formed in or engaged through the grooves 31 for solidly or firmly coupling the spacers 32 together. The spacers 32 may also be applied onto the cathode plates 30 or the anode plates 40 with such as printing processes.

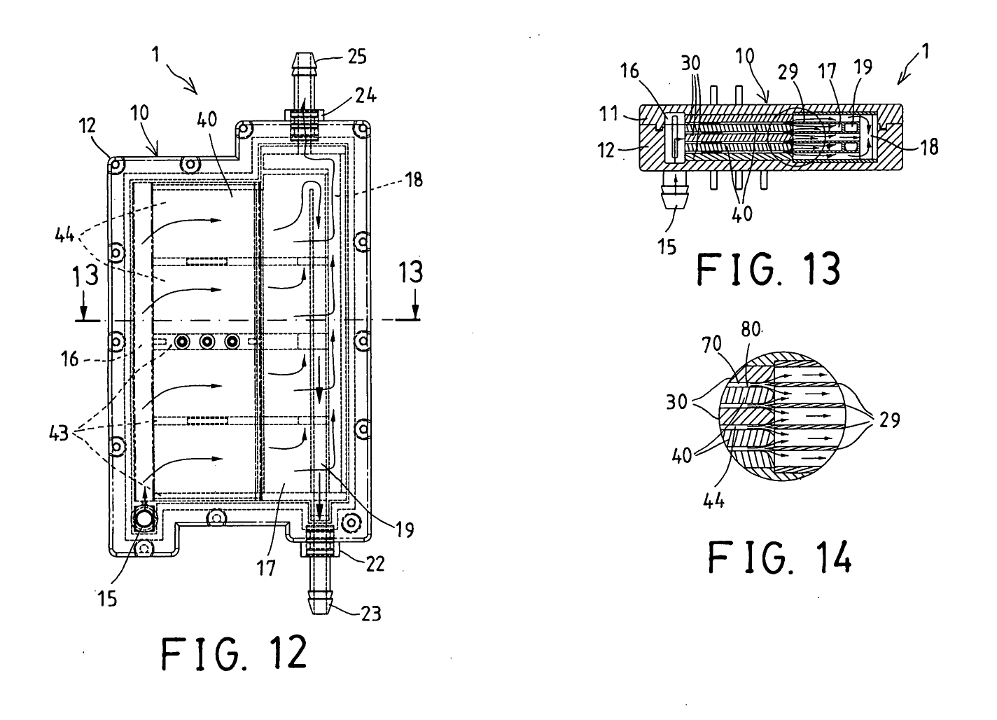

The receptacle 10 may include one or more pins or pegs 27 (FIGS. 1, 4) extended from each or one of the housing members 11, 12 and engaged through the cathode plates 30 and the anode plates 40 for stably supporting and anchoring the cathode plates 30 and the anode plates 40 in the chamber 14 of the receptacle 10. Alternatively, as shown in FIGS. 11-12, the anode plate 40 may include one or more grooves 42, such as lateral or horizontal grooves 42 formed therein, and one or more bars or spacers 43 are formed or attached or secured onto two opposite sides of the anode plate 40 for engaging with the cathode plates 30 and for separating the cathode plates 30 and the anode plates 40 away from each other, and for forming or defining the flowing passage 44 between the cathode plates 30 and the anode plates 40 (FIG. 12).

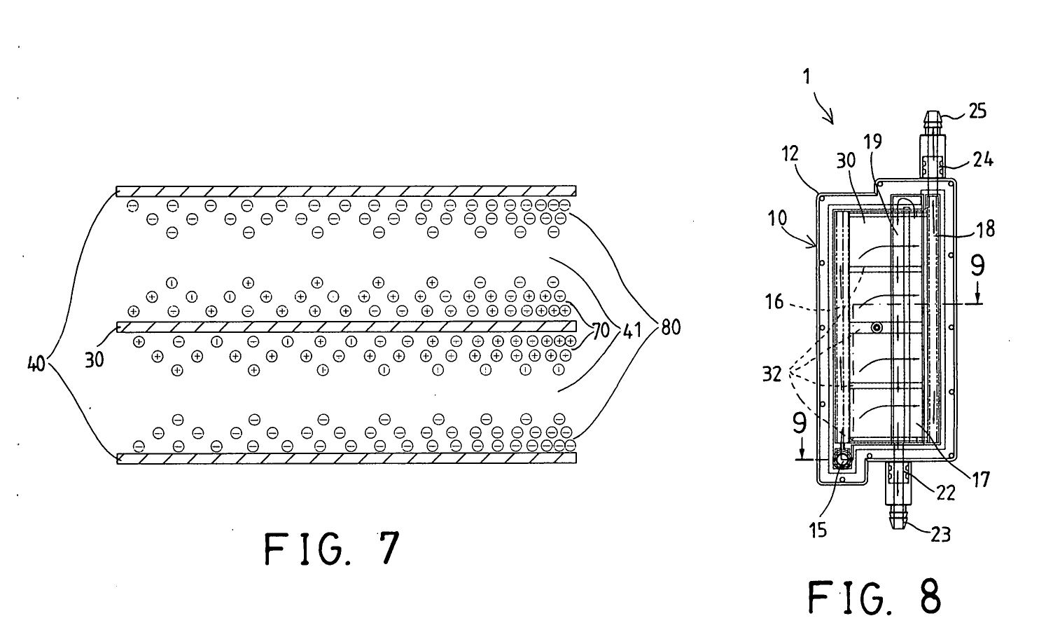

In operation, as shown in FIG. 7, when the cathode plate 30 and the anode plates 40 are energized or actuated or operated, the anolyte 70 may be generated and attracted toward the cathode plate 30 and may thus be forced or caused to flow closer to the cathode plate 30 (FIG. 6), and the catholyte 80 may be generated and attracted toward the anode plates 40 and may thus be forced or caused to flow closer to the anode plates 40 (FIG. 6). As best shown in FIGS. 5-6, the anode plates 40 each preferably include a bent segment or deflector 45 formed in one end that is located or extended into the first compartment 17 of the receptacle 10 for deflecting or guiding the catholyte 80 to flow into the first compartment 17 of the receptacle 10.

As also best shown in FIGS. 5-6, the receptacle 10 further includes another partition 28 provided and disposed between the first and the second compartments 17, 18 for separating the first and the second compartments 17, 18 from each other, and the partitions 28 each include a separating or guiding projection 29 extended or directed toward or into the middle portion of the flowing passage 41 that is formed between the cathode plate 30 and the anode plate 40 respectively for separating the catholyte and the anolyte away from each other, and for further guiding the catholyte 80 to flow into the first compartment 17 of the receptacle 10, and for guiding the anolyte 70 to flow into the second compartment 18 of the receptacle 10.

In operation, as shown in FIGS. 5-7, the brine or other electrolytic solutions may be supplied and flown into the buffer space 16 and then into the chamber 14 via the inlet port 15 of the receptacle 10, and the buffer space 16 may be provided for slowing or buffering the flowing speed of the electrolytic solutions and for preventing the eddy current of the electrolytic solutions from being generated within the buffer space 16 and the chamber 14 of the receptacle 10, and thus for allowing the electrolytic solutions to smoothly flow through the chamber 14 and the flowing passage 41 of the receptacle 10.

The anolyte 70 may be generated and attracted toward the cathode plate 30 and may thus be forced or caused to flow closer to the cathode plate 30, and may then be guided to flow into the second compartment 18 of the receptacle 10 by the cathode plate 30 itself and/or by the separating or guiding projections 29 of the partitions 28, and may then be guided to flow out of the receptacle 10 via the exits 24 and/or the connector 25 of the housing members 11, 12 respectively, for then allowing the anolyte 70 to be collected for further use.

Simultaneously, the catholyte 80 may be generated and attracted toward the anode plates 40 and may thus be forced or caused to flow closer to the anode plates 40, and may then be guided to flow into the first compartment 17 of the receptacle 10 by the bent segments or deflectors 45 of the anode plates 40 and/or the separating or guiding projections 29 of the partitions 28, and may then be guided to flow into the conduits 19 of the receptacle 10 and then to flow out of the receptacle 10 via the coupler 23 or the outlet ports 22 of the housing members 11, 12 respectively, for allowing the catholyte 80 to be collected for further use.

The cathode plate 30 and the anode plates 40 may thus be used for generating the anolyte 70 and the catholyte 80 respectively, and for guiding the catholyte 80 to flow into the first compartment 17 of the receptacle 10, and then to flow into the conduits 19 of the receptacle 10, and for guiding the anolyte 70 to flow into the second compartment 18 of the receptacle 10. The bent segments or deflectors 45 of the anode plates 40 and/or the separating or guiding projections 29 of the partitions 28 may thus be acted as a separating means or device for separating the anolyte 70 and the catholyte 80 away from each other, and for effectively guiding the catholyte 80 and the anolyte 70 to flow into the first compartment 17 and the second compartment 18 of the receptacle 10 respectively.

As shown in FIGS. 8-10, the single anode plate 40 and the single cathode plate 30 may also be used for generating the catholyte 80 and the anolyte 70 respectively, and for guiding the catholyte 80 and the anolyte 70 to flow into the first compartment 17 and the second compartment 18 of the receptacle 10 respectively. The separating or guiding projection 29 may further be used and extended or directed toward or into the middle portion of the flowing passage 41 that is formed between the cathode plate 30 and the anode plate 40 for effectively separating the catholyte 80 and the anolyte 70 away from each other, and then for effectively guiding the catholyte 80 and the anolyte 70 to flow into the first compartment 17 and the second compartment 18 of the receptacle 10 respectively. The cathode plate 30 may also include a bent segment or deflector 33 formed in one end for deflecting or guiding the anolyte 70 to flow into the second compartment 18 of the receptacle 10.

As shown in FIGS. 11-14, the two or more cathode plates 30 and the two or more anode plates 40 may also be provided and used for generating the anolyte 70 and the catholyte 80 respectively, and for guiding the catholyte 80 and the anolyte 70 to flow into the first compartment 17 and the second compartment 18 of the receptacle 10 respectively. The separating or guiding projection 29 may also be used and extended or directed toward or into the middle portion of the flowing passages 44 that are formed between the cathode plates 30 and the anode plates 40 and the spacers 43, for effectively separating the catholyte 80 and the anolyte 70 away from each other, and then for effectively guiding the catholyte 80 and the anolyte 70 to flow into the first compartment 17 and the second compartment 18 of the receptacle 10 respectively.

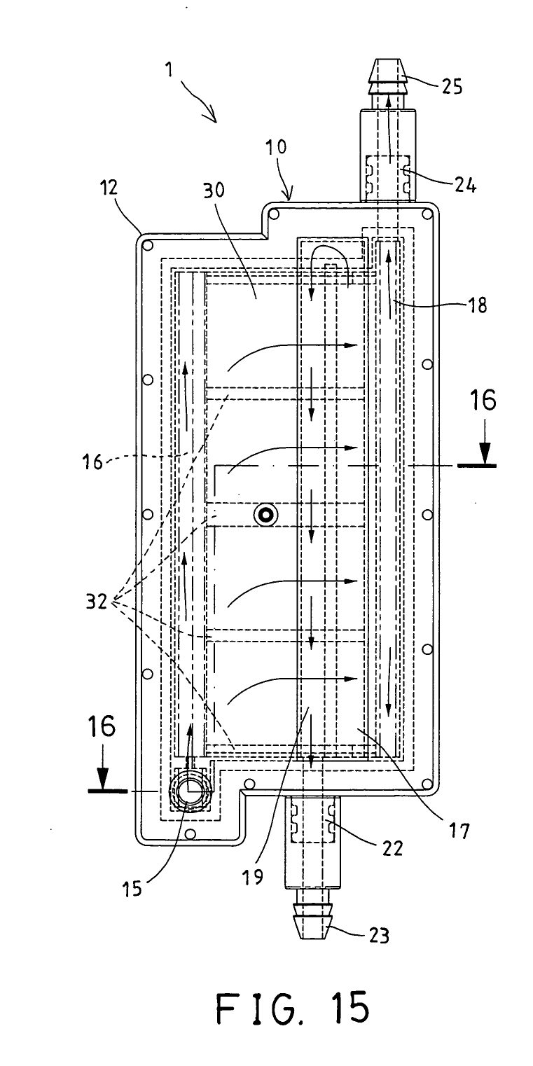

As shown in FIGS. 15-17, the anode plate 40 may include the bent segment or deflector 45 formed in one end that is located in the first compartment 17 of the receptacle 10, and may have the bent segment or deflector 45 to be energized with a higher voltage in order to attract more catholyte 80 toward the anode plate 40, and simultaneously to repel the anolyte 70 away from the anode plate 40, and toward the cathode plate 30.

Accordingly, the separating device in accordance with the present invention may be provided for separating anolyte from catholyte in electrolyzers or for preventing the anolyte and the catholyte from being mixed or blended with each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electrolyzer comprising:
a receptacle including a chamber formed in said receptacle, and including an inlet port for receiving an electrolytic solution,
at least one cathode plate and at least one anode plate disposed in said chamber of said receptacle and separated from each other for forming a flowing passage between said at least one cathode plate and said at least one anode plate, said at least one cathode plate being provided for attracting anolyte of the electrolytic solution toward said at least one cathode plate, and said at least one anode plate being provided for attracting catholyte of the electrolytic solution toward said at least one anode plate,
said receptacle including a first compartment and a second compartment communicating with said chamber of said receptacle respectively, said first and said second compartments being separated from each other and not communicating with each other, and
means for guiding the catholyte and the anolyte to flow into said first and said second compartments of said receptacle respectively.

2. The separating device as claimed in claim 1, wherein said receptacle includes a conduit formed in said receptacle and communicating with said first compartment of said receptacle, and an outlet port communicating with said conduit for flowing out the catholyte.

3. The separating device as claimed in claim 2, wherein said receptacle includes a partition disposed between said first compartment and said conduit of said receptacle, and a passage formed in said partition for communicating said first compartment with said conduit of said receptacle.

4. The separating device as claimed in claim 2, wherein said receptacle includes two housing members secured together, said housing members each includes said outlet port formed therein, and a coupler coupled to said outlet ports of said housing members respectively.

5. The separating device as claimed in claim 2, wherein said receptacle includes a window for blocking said first compartment with said conduit of said receptacle and for allowing a flowing of the catholyte from said first compartment toward said conduit of said receptacle to be seen by people.

6. The separating device as claimed in claim 1, wherein said receptacle includes an exit communicating with said second compartment for flowing out the anolyte.

7. The separating device as claimed in claim 1, wherein said receptacle includes at least one peg extended therefrom and engaged through said at least one cathode plate and said at least one anode plate for stably supporting and anchoring said at least one cathode plate and said at least one anode plate in said chamber of said receptacle.

8. The separating device as claimed in claim 1, wherein at least one spacer is disposed between said at least one cathode plate and said at least one anode plate for separating said at least one cathode plate and said at least one anode plate from each other.

9. The separating device as claimed in claim 1, wherein said at least one cathode plate includes at least one groove formed therein, and said at least one spacer includes a portion engaged into said at least one groove of said at least one cathode plate.

10. The separating device as claimed in claim 1, wherein said guiding means includes a deflector extended from said at least one cathode plate and extended into said first compartment of said receptacle for guiding the catholyte to flow into said first compartment of said receptacle.

11. The separating device as claimed in claim 1, wherein said guiding means includes a guiding projection extended and directed into a middle portion of said flowing passage which is formed between said at least one cathode plate and said at least one anode plate for separating the catholyte and the anolyte from each other, and for guiding the catholyte to flow into said first compartment of said receptacle and for guiding the anolyte to flow into said second compartment of said receptacle.

12. The separating device as claimed in claim 11, wherein said receptacle includes a partition disposed between said first and said second compartments for separating said first and said second compartments from each other, and said guiding projection is extended from said partition.

13. The separating device as claimed in claim 1, wherein said receptacle includes a buffer space communicating with said chamber and said inlet port of said receptacle.

14. The separating device as claimed in claim 13, wherein said buffer space includes an area greater than that of said inlet port of said receptacle for buffering the electrolytic solution.
